(19) United States
(12) Patent Application Publication
(10) Pub. No.: US 2007/0076784 A1
(43) Pub. Date: Apr. 5, 2007

(54) Techniques to improve redundancy for multi-carrier wireless systems

(76) Inventors: Fei Frank Zhou, San Diego, CA (US); Zhouyue Pi, San Diego, CA (US); Zhigang Rong, San Diego, CA (US); Lin Ma, San Diego, CA (US)

Correspondence Address: BRAKE HUGHES PLC;c/o PORTFOLIOIP, c/o PORTFOLIOIP, P.O. BOX 52050, MINNEAPOLIS, MN, 55402, US

(21) Appl. No.: 11/482,180

(22) Filed: Jul. 6, 2006

Related U.S. Application Data
(60) Provisional application No. 60/697,189, filed on Jul. 7, 2005.

(51) Int. Cl. H04B 1/00; H04K 1/10

(52) U.S. Cl. 375/141; 375/260

(57) ABSTRACT

Various techniques are disclosed to improve redundancy in multi-carrier wireless systems. An example technique is provided that may include commonly encoding a block of data, modulating the encoded block of data across a plurality of carriers, and transmitting via a wireless link the encoded block of data including the plurality of carriers. The modulating may, for example, include modulating a first portion of the encoded block onto a first carrier and modulating a second portion of the encoded block onto a second carrier, wherein encoded data on the first carrier for the block of data may be used for error detection and/or error correction of encoded data on the second carrier for the block of data. Error detection and correction for the encoded block may be performed across the plurality of carriers, which may provide frequency diversity for the block of data.

### CROSS-REFERENCE TO RELATED APPLICATIONS

This application claims priority to U.S. Provisional Patent Application Ser. No. 60/697,189 filed on Jul. 7, 2005, hereby incorporated by reference.

### BACKGROUND

Multi-carrier modulation is a modulation technique where data is modulated onto multiple carriers or subcarriers, rather than being modulated onto a single carrier. Multi-carrier Code Division Multiple Access (MC-CDMA) is an example of multi-carrier modulation where each carrier occupies a separate frequency band. In each frequency band, the transmission technology or format may be similar to or the same as those used in a single carrier system. In doing so, a multi-carrier CDMA system may be able to overlay with single carrier CDMA systems to utilize spectrum more efficiently and achieve better backward compatibility. More specifically, the cdma2000 High Rate Packet Data (Revision 0) system—which is commonly referred to as 1xDO system—is a single carrier system where all Access Terminals (AT) communicate with Access Network (AN) over 1.25 MHz bandwidth in either the forward link or the reverse link. While an NxDO system is a multi-carrier CDMA system that allows ATs to communicate with AN over multiple 1.25 MHz bands—each band utilizes transmission technology and format similar to those used in a 1xDO system. Orthogonal Frequency Division Multiplexing (OFDM) is another example of multi-carrier modulation where the subcarriers are orthogonal to each other. Multi-carrier (MC) techniques, such as OFDM, allow the use of longer symbol periods for the same data rate (as compared to single carrier systems) and may reduce problems associated with multi-path delays and inter-symbol interference. MC and OFDM offer frequency diversity as well.

FIG. 1 is a diagram illustrating a transmission of packets across multiple carriers. In FIG. 1, three separate data streams are independently coded. Each separately coded stream is then transmitted over a different carrier or subcarrier. For example, a first stream is independently coded and transmitted over a carrier C1, a second data stream is independently coded and transmitted over a carrier C2, and a third data stream is independently coded and then transmitted over a carrier C3. The packets Pᵢⱼ^{k} are shown for each stream, where k is the index of carriers, i is the index of packets, and j is the index of sub-packets. The packets for each of the streams may be transmitted asynchronously or at different times compared to the packets on the other carriers. However, frequency selective fading may cause, for example, a fade on one of the carriers, such as C1. A fade on carrier C1 may cause significant errors or loss of data such that one or more packets on C1 may be lost or unrecoverable.

### SUMMARY

Various embodiments are disclosed relating to techniques to improve redundancy for multicarrier wireless systems.

According to an example embodiment a technique is provided that may include commonly encoding a block of data, modulating the encoded block of data across a plurality of carriers, and transmitting via a wireless link the encoded block of data including the plurality of carriers. In an example embodiment, the modulating may include modulating a first portion of the coded data block onto a first carrier, and modulating a second portion of the coded data block onto a second carrier. In an example embodiment, the transmitting may include spreading a first portion of the encoded block of data using a first spreading code, spreading a second portion of the encoded block of data using a second spreading code, and transmitting the first and second portions of the spread data via first and second carriers, respectively. Also, a preamble for the transmitted first portion of spread data may include a first MAC index to identify the first spreading code, and a preamble for the transmitted second portion of spread data may include a second MAC index to identify the second spreading code. In another example embodiment, the transmitting may include transmitting one or more packets or sub-packets for the coded data block substantially synchronously, or at about the same time, for (or across) the plurality of carriers.

According to another embodiment, another technique is provided that may include receiving a data block for transmission from one or more data sources, commonly encoding the received data block to generate a coded data block and modulating the coded data block across a plurality of carriers for transmission over a wireless link. The modulating may include modulating a first portion of the encoded block onto a first carrier and modulating a second portion of the encoded block onto a second carrier, wherein encoded data on the first carrier for the block of data may be used for error detection and/or error correction of encoded data on the second carrier for the block of data.

According to another example embodiment, a technique is provided that may include receiving, via wireless link, a commonly encoded block of data that has been modulated across a plurality of carriers, the plurality of carriers including a first carrier and a second carrier. The technique may also include using encoded data on the first carrier for the block of data for error detection and/or error correction for the second carrier for the block of data.

According to another example embodiment, an apparatus is provided. The apparatus may include an encoder adapted to encode a block of data, an interleaver adapted to interleave the encoded block of data, a multi-carrier modulator adapted to modulate the interleaved block of data across a plurality of carriers, the plurality of carriers including first and second carriers. In an example embodiment, the data on the first carrier for the block of data is adapted to be used for error detection and/or error correction for data on the second carrier for the block of data.

According to another example embodiment, an apparatus is provided. The apparatus may include a multi-carrier demodulator adapted to demodulate a received block of data across a plurality of carriers, the block of data having been commonly encoded across the plurality of carriers. The apparatus may also include a de-interleaver adapted to de-interleave the demodulated block of data, a decoder adapted to decode the de-interleaved block of data, where the plurality of carriers may include first and second carriers. In an example embodiment, the apparatus may be adapted to use data on the first carrier for the block of data to perform, if necessary, error detection and/or error correction for data on the second carrier for the block of data. In another example embodiment, if there are three carriers, data received on two or three of the carriers may be used to detect and/or correct errors on one of the carriers for the block of data.

According to yet another example embodiment, a technique is provided, for example, to detect a packet in a multicarrier wireless system. The technique may include receiving a multi-carrier signal including receiving a preamble of a packet on each of a plurality of carriers, correlating the preamble received on each of the plurality of carriers to obtain a correlation result for each carrier, and comparing the correlation results to a threshold. Comparing the correlation results may include, for example, adding the correlation results of the plurality of carriers to provide a multi-carrier correlation sum, and comparing the correlation sum to a threshold.

### BRIEF DESCRIPTION OF THE DRAWINGS

FIG. 1 is a diagram illustrating a transmission of packets across multiple carriers.

FIG. 2 is a diagram illustrating a transmission of packets across multiple carriers according to an example embodiment.

FIG. 3 is a block diagram of a wireless system according to an example embodiment.

FIG. 4 is a flow chart illustrating operation of a wireless device according to an example embodiment.

FIG. 5 is a flow chart illustrating operation of a wireless device according to another example embodiment.

FIG. 6 is a flow chart illustrating operation of a wireless device according to another example embodiment.

FIG. 7 is a flow chart illustrating operation of a wireless device according to an example embodiment.

FIG. 8 is a block diagram illustrating an apparatus that may be provided in a wireless device or apparatus according to an example embodiment.

### DETAILED DESCRIPTION

According to an example embodiment, a block of data may be received and commonly (or jointly) coded. The block of data may be received and commonly encoded, using any number of well-known redundancy coding techniques, such as block coding, convolutional coding, turbo coding, etc. The commonly (or jointly) encoded data block may then be modulated onto multiple carriers for transmission. According to an example embodiment, multiple data streams may be received (or generated) and then jointly (or commonly) encoded or coded together. The multiple data streams may be combined for encoding using, for example, a parallel-to-serial converter. Alternatively, a single data stream may be received and coded together.

According to an example embodiment, modulating a commonly encoded block of data across multiple carriers (or subcarriers) may allow for a more robust mechanism for error detection and correction across multiple carriers by making use of frequency diversity. For example, modulating a commonly encoded block of data across multiple carriers may allow the redundancy (or redundant) information in carrier C1 to be used for error detection and correction not only for carrier C1, but also for the other carriers C2 or C3 since the encoded bits transmitted on C1, C2 and C3 are commonly or jointly encoded (e.g., the block of data may be encoded together as one block, and then modulated across multiple carriers or transmitted using multiple carriers, e.g., to provide frequency diversity for the block of data). Each carrier C1, C2, C3, etc. may be at a different frequency.

For example, a block of data (e.g., from one stream or multiple streams) may be commonly encoded, and then modulated for transmission onto carriers C1, C2 and C3. If frequency selective fading or distortion occurs on carrier C3 at the receiver, there is a significant possibility that a fade or distortion may not occur at that same time on either C1 or C2. Therefore, according to an example embodiment, the receiver may use the redundancy encoded (or redundant) information provided on either carriers C1 and/or C2 to detect and/or correct errors received on carrier C3 since the block of coded data modulated across carriers C1, C2 and C3 for transmission was commonly or jointly coded.

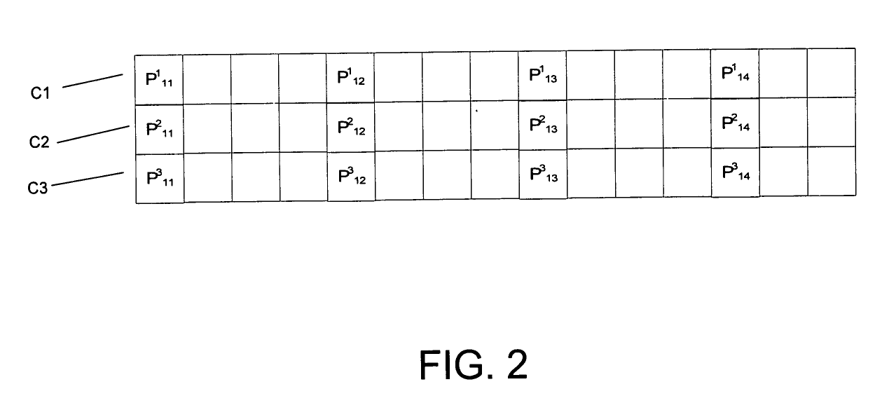

FIG. 2 is a diagram illustrating a transmission of packets across multiple carriers according to an example embodiment. In the example shown in FIG. 2, a block of data (e.g., from one or more streams) may be commonly encoded and then modulated onto or across multiple carriers including carriers C1, C2 and C3. One or more packets of data from the commonly encoded block may be modulated onto (transmitted on) the multiple carriers, with the three carriers C1, C2 and C3 being used in this example to transmit the commonly encoded block of data. For example, one-third (⅓) of the code bits from the commonly encoded data block may be transmitted on each of the three carriers C1, C2 and C3. While three carriers are shown here, any number of carriers or subcarriers may be used. For example, if there are N carriers, then 1/N of the code bits from the commonly encoded block may be transmitted on each of the N carriers. This is merely an example, and the code bits may be divided up evenly or unevenly across the available number of carriers or subcarriers.

Referring to FIG. 2, the packets Pᵢⱼ^{k} are shown, where k is the index of carriers, i is the index of packets, and j is the index of sub-packets. The sub-packets for the packet transmitted (or modulated) onto carrier C l are shown in the top row, and include four sub-packets: P¹₁₁, P¹₁₂, P¹₁₃ and P¹₁₄. The sub-packets transmitted (or modulated) on carrier C2 are shown in the middle row, and include four sub-packets: P²₁₁, P²₁₂, P²₁₃ and P²₁₄. The sub-packets transmitted (or modulated) on carrier C3 are shown in the bottom row of FIG. 2, and include four sub-packets: P³₁₁, P³₁₂, P³₁₃ and P³₁₄. (While the packet and sub-packet indices are the same for the sub-packets for the three carriers, the data transmitted in these packets is actually different data from the commonly encoded block of data.

For example, in the embodiment shown in FIG. 2, data bits from, say, three different data streams (or the same stream), may be commonly encoded as a single encoded block of data. The three streams, for example may be from (or to) a single user or Access Terminal or from(or to) different users (or Access Terminals). For example, 100 data bits from each of three different data streams may be received (300 data bits total in the data block) may be commonly encoded as one block using a code rate, for example, of ¼, resulting in 1200 total code bits for this block. The code bits in this block may be interleaved and modulated (e.g., using BPSK or binary phase shift keying or some other modulation technique) and then modulated onto the three carriers C1, C2 and C3. For example, 400 of the 1200 code bits for this block may be modulated onto each carrier, C1, C2 and C3.

In the example shown in FIG. 2, each packet may include four sub-packets, with each sub-packet carrying 100 code bits. This would allow the 1200 code bits for this commonly encoded block to be transmitted on the three carriers C1, C2 and C3 using one packet per carrier (including 4 sub-packets per packet), as shown in the example of FIG. 2). The different packets and sub-packets for the three different carriers C1, C2 and C3 transmit code bits from the same commonly (or jointly) encoded data block, according to an example embodiment.

As noted above, the modulation of a commonly or jointly encoded block of data across a plurality of carriers or subcarriers may allow for a more robust error detection and/or correction technique through frequency diversity. Incremental redundancy may be obtained by transmitting code bits of the commonly encoded block on each additional carrier or subcarrier (e.g., 2 carriers, 3 carriers, 4 carriers, 5 carriers, or more).

In addition, the common or joint encoding of a larger block of data (e.g., rather than independently encoding smaller blocks of data) may, in some cases, allow for a greater coding gain or higher coding rate. For example, if Turbo coding is used, a higher coding gain or higher coding rate may be obtained when encoding a larger block of data, although the various embodiments are not limited thereto.

In addition, according to an example embodiment, the packets and/or sub-packets on the different carriers or subcarriers may be transmitted synchronously (e.g., packets or sub-packets on the different carriers transmitted during the same slot or at about the same time). For example, as shown in FIG. 2, sub-packet P¹₁₁ (on carrier C1), sub-packet P²₁₁ (on carrier C2) and sub-packet P³₁₁, (on carrier C3) may be transmitted synchronously (in this example, all three sub-packets are transmitted during the same time slot, or at about the same time). Other sub-packets may also be transmitted synchronously across the multiple carriers as well, as shown the example of FIG. 2 (e.g., sub-packet 2, sub-packet 3, sub-packet 4, for each of the carriers).

Transmitting packets or sub-packets synchronously across the multiple carriers may allow the receiver to perform error detection and correction across the multiple carriers/subcarriers for each sub-packet. For example, a block of data may be commonly encoded and divided into multiple packets (or sub-packets) with, for example, at least one packet (or sub-packet) being transmitted synchronously on each of a plurality of carriers (or subcarriers). Also, commonly or jointly encoding a larger block of data (such as for a synchronous transmission using multiple carriers) may allow for a larger coding gain as noted above, at least in some cases.

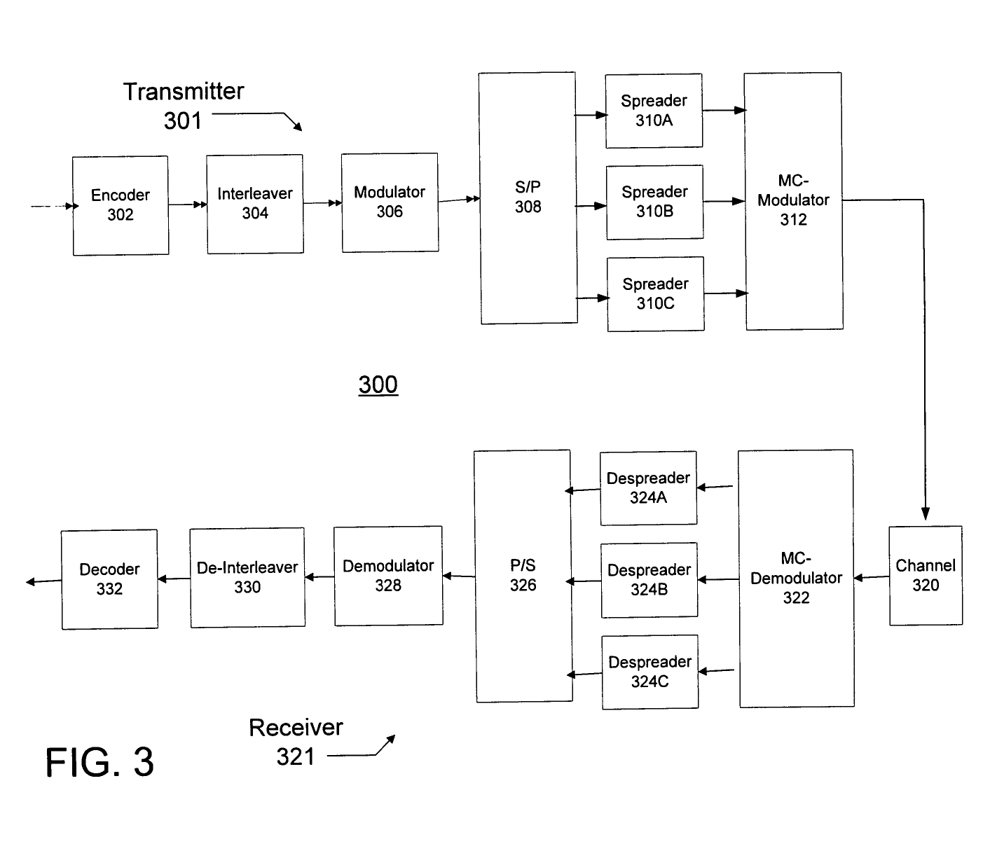

FIG. 3 is a block diagram of a wireless system according to an example embodiment. Wireless system 300 may include a wireless transmitter 301 and a wireless receiver 321. The wireless transmitter 301 and wireless receiver 321 may each be part of different wireless systems and coupled via a channel 320 (such as a wireless channel). In an example embodiment, the wireless transmitter 301 may be provided in an Access Network device such as a base station or other device, and the receiver 321 may be provided, for example, within an Access Terminal such as a cellular device, mobile device, mobile station, wireless local area network (WLAN) device, a wireless personal digital assistant (PDA) or other wireless device.

Alternatively, wireless transmitter 301 and wireless receiver 321 may both be provided within a single device, such as an Access Network device or base station or an Access Terminal or other wireless or mobile device. Although not shown, wireless transmitter 301 and receiver 321 may include additional components such as an antenna and the like. Also, the various blocks of wireless system 300 may be implemented in hardware, software, firmware, logic or a combination of these. For example, a wireless system 300 (or a transmitter 301 or a receiver 321) may include hardware circuits or logic for some blocks (or portions thereof), while using a controller or microprocessor to execute software or firmware to perform functions associated with the other blocks, although the various embodiments are not limited thereto.

Referring to FIG. 3, transmitter 301 may include an encoder 302 to encode data bits to output a block of code bits using a coding technique, such as block coding, convolutional coding, turbo coding, or any other coding technique. According to an example embodiment, encoder 302 may commonly encode a block of data for transmission across multiple carriers to enhance the receiver's ability to perform error detection and correction. Next, an interleaver 304 may interleave the block of code bits. Next, a modulator 306 may modulate the interleaved code bits using any well-known modulation technique, such as binary phase shift keying (BPSK), quadrature phase shift keying (QPSK), quadrature amplitude modulation (QAM), etc.

In FIG. 3, a serial-to-parallel block (or circuit) 308 may divide the interleaved block of code bits into multiple streams or sub-blocks. In this example embodiment, three different sub-blocks are shown. For example, if there are 1200 code bits (which are commonly coded), then there may be 400 code bits (of the 1200 total) output from each of the three outputs of S/P block 308.

Although not required, the data sub-blocks may then be spread using a spreading code. In an example embodiment, the spreading codes may include codes having orthogonal properties such as Walsh codes, or codes having good correlation properties such as PN codes, or other spreading codes, for example. This orthogonal property or good correlation property of the spreading codes may allow each user (or each mobile device) to recover his data using the same spreading code while minimizing the interference from other users.

Three spreaders 310 are shown coupled to S/P block 308, including spreaders 310A, 310B and 310C. In one embodiment, each of the sub-blocks (or streams) output from S/P block 308 may be spread using a different spreading code. In an example embodiment, there may be a different spreader 310 for each carrier (or subcarrier) to be used for spreading the commonly encoded block of data. In the example embodiment shown in FIG. 3, there may be three spreaders (310A, 310B and 310C), one spreader for each of the carriers (C1, C2 and C3) to be used for transmission of the commonly encoded block.

In addition, a different spreading code may typically be assigned to each carrier or to each spreader. For example, a first spreading code may be used by spreader 310A to spread a first sub-block of data (from the commonly encoded block) to be transmitted over a carrier C1, a second spreading code may be used by spreader 310B to spread a second sub-block of data (from the commonly encoded block of data) to be transmitted over a carrier C2, and a third spreading code may be used to spread a third sub-block of data (from the same commonly encoded block of data) to be transmitted over a carrier C3. According to an example embodiment, a set of spreading codes may be assigned to a user or to an Access Terminal or mobile device. The spreading codes may be fixed or pre-set for a user, or the spreading codes may be dynamically assigned by the Access Network device or base station, such as by providing each user with a spreading code ID for each of the 3 spreading codes assigned to the user. The Access Network or base station may assign or provide these three spreading codes to each user (or Access Terminal) during call setup, for example, or at some other time.

In FIG. 3, a multi-carrier (MC) modulator 312 may then modulate the spread data onto each of a plurality of carriers or subcarriers. For example, the sub-block of data spread by spreader 310A may be modulated onto carrier C1, the sub-block of data spread by spreader 310B may be modulated onto carrier C2 and the sub-block of data spread by spreader 310C may be modulated onto carrier C3. Each of these different carriers or subcarriers may be provided at a different frequency or frequency band. As noted above, in an example embodiment, each packet or sub-packet transmitted on each carrier (or sub-carrier) may be synchronized with the transmission of packets or sub-packets transmitted on the other carriers or sub-carriers. After being transmitted over a channel 320 (such as a wireless channel), the modulated information is received by receiver 321.

Receiver 321 (FIG. 3) includes a multi-carrier (MC) demodulator for demodulating each of the multiple carriers, e.g., C1, C2, C3. The demodulated information (e.g., chips) is input to three different despreaders, 324A, 324B and 324C. Despreaders 324A, 324B and 324C may despread or correlate the received (MC demodulated) spread information using the same spreading codes that were assigned to this user or Access Terminal and used by spreaders 310 at the receiver. If the spreading codes used by despreaders 324 match the spreading codes used by spreaders 310, the result of this correlation (or despreading) process may output the original coded bits. Therefore, an Access Terminal or user device may correlate the received information with its assigned spreading codes to identify data or code bits transmitted or addressed to it, and reject or filter the information or code bits transmitted to other devices or Access Terminals.

The despread information may then be passed through a parallel-to-serial block 326, and then demodulated by demodulator 326 and de-interleaved by de-interleaver 330. Next, the de-interleaved information is then decoded by decoder 332. In an example embodiment, one or more bit errors in the received block of data may be detected and corrected at decoder 332. Decoder 332 may, for example, use redundancy encoded (or redundant) information in the code bits transmitted on one carrier (e.g., C1) to correct errors in another carrier (e.g., C2 or C3), since the original sub-blocks transmitted on the three carriers (C1, C2 and C3) were (originally) commonly or jointly encoded. This may provide a more robust error detection and correction mechanism by taking advantage of frequency diversity of the multiple carriers or subcarriers.

The packets on each carrier may be transmitted synchronously as shown in FIG. 2. Each packet may include a plurality of sub-packets, with a packet preamble being provided, for example, on the first sub-packet of each carrier.

Table 1 below describes some example packet formats and DRC (data rate control) mapping for the multi-carrier transmission described above. Table 1 includes a DRC Index (or index for packet formats, which may be used for data rate control or transmission control), the rate, the span or number of slots (for the packet, indicating the number of sub-packets per packet) and the transmission format.

| | Rate | | |
|---|---|---|---|
| DRC | Metric | Span | Transmission Format |
| Index | (kbps) | (slots) | (PacketSize, Slots, PreambleSize) |
| 0x0 | 0 | 16 | (3072, 16, 1024) |
| 0x1 | 38.4 | 16 | (3072, 16, 1024) |
| 0x2 | 76.8 | 8 | (3072, 8, 512) |
| 0x3 | 153.6 | 4 | (3072, 4, 256) |
| 0x4 | 307.2 | 2 | (3072, 2, 128) |
| 0x5 | 307.2 | 4 | (6144, 4, 128) |
| 0x6 | 614.4 | 1 | (3072, 1, 64) |
| 0x7 | 614.4 | 2 | (6144, 2, 64) |
| 0x8 | 921.6 | 2 | (9216, 2, 64) |
| 0x9 | 1228.8 | 1 | (6144, 1, 64) |
| 0xa | 1228.8 | 2 | (12288, 2, 64) |
| 0xb | 1843.2 | 1 | (9216, 1, 64) |
| 0xc | 2457.6 | 1 | (12288, 1, 64) |
| 0xd | 1536 | 2 | (15360, 2, 64) |
| 0xe | 3072 | 1 | (15360, 1, 64) |

According to an example embodiment, an independent MAC (media access control) Index may be transmitted within the preamble of each carrier (e.g., within the preamble on each carrier, C1, C2, C3, etc.). The MAC Index transmitted on a carrier may, for example, identify a spreading code or Walsh code to be used by a user or Access Terminal for correlating that carrier. For example, for three carriers, an Access Network device may transmit an independent MAC Index on the preamble for each carrier. Alternatively, the MAC Index for each of the three carriers assigned to a user or Access Terminal may be provided to the Access Terminal during call setup.

According to an example embodiment, the Access Terminal or user device may correlate the preamble for each of the three carriers using the MAC index provided over that carrier. For example, the Access Terminal may use the spreading code corresponding to the MAC Index provided on carrier C1 to correlate the information received on carrier C1, use the spreading code corresponding to the MAC Index provided on (e.g., the preamble of) carrier C2 to correlate the information received on carrier C2. Similarly, the spreading code corresponding to the MAC Index provided on carrier C3 may be used to correlate the signals received over carrier C3, etc.

In an example embodiment, an improved or more robust technique may be provided for detecting a preamble of a packet. In a single carrier system, noise, distortion, frequency selective fading can inhibit the detection of the preamble of a packet. If the preamble is missed or mis-detected, then the entire packet will typically be missed or lost. Therefore, according to an example embodiment, an Access Terminal or other device may correlate the preambles received on multiple carriers. This may be performed, for example, as follows. The preamble received on a packet for each carrier is correlated using the spreading code corresponding to the MAC Index received for each carrier. The correlation results for the three carriers may be added together, and this sum may be compared to a threshold (which in an example embodiment, may be approximately equal to 3× the standard correlation value for a single carrier). If the sum is greater than the threshold, then this is a positive correlation indicating the packets assigned to the Access Terminal have been received. However, this is merely one example, and the various embodiments are not limited thereto. Therefore, when the preamble on one of the carriers is experiencing noise, fading or distortion, the preamble signals on the other two carriers may not be experiencing such problems, and may allow a more robust technique to detect a preamble through the use of frequency diversity.

According to an example embodiment, at a transmitter, a block of data may be received and commonly encoded. The commonly encoded block of data may be transmitted via (or modulated onto) a plurality of carriers. A different spreading code may be used to spread code bits for modulation onto each carrier. Also, the commonly encoded block of data may be transmitted by synchronously transmitting packets or sub-packets for each of the plurality of carriers. At a receiver, the plurality of subcarriers may each be demodulated and de-spread using the spreading codes assigned to each of the carriers. Because the information transmitted on each carrier was commonly encoded, an error detected on one carrier may be corrected based on information (e.g., code bits) provided on another carrier.

According to an example embodiment, an allocation of subcarriers and/or spreading codes may be varied over time for one or more signal streams. The varying of subcarriers and/or spreading codes may be performed according to a pattern, such as a subcarrier-time-code pattern for example. Also, a wireless transmitter may include a time varying spreading and subcarrier mapping block to dynamically vary the mapping or allocation of subcarriers and spreading codes to one or more signal streams, and a multicarrier modulator to modulate information onto one or more subcarriers as allocated by the time varying spreading and subcarrier mapping block.

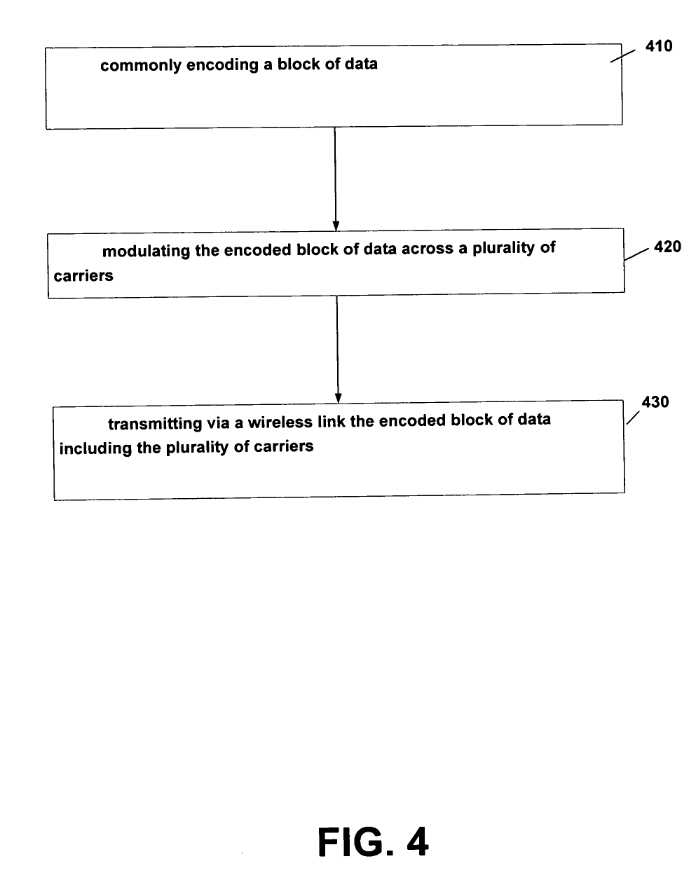

FIG. 4 is a flow chart illustrating operation of a wireless device according to an example embodiment. At 410, a block of data may be commonly encoded (or encoded together as one block). At 420, the encoded block of data may be modulated across or via a plurality of carriers. For example, a first portion of the encoded block may be modulated onto a first carrier and a second portion of the encoded block may be modulated onto a second carrier. At 430, the encoded block of data may be transmitted including (or across) the plurality of carriers. In this manner, by modulating a commonly encoded block of data onto multiple carriers, with each carrier, for example, at a different frequency, frequency diversity across the multiple carriers may be used, for example, to allow error detection and/or error correction across the multiple carriers.

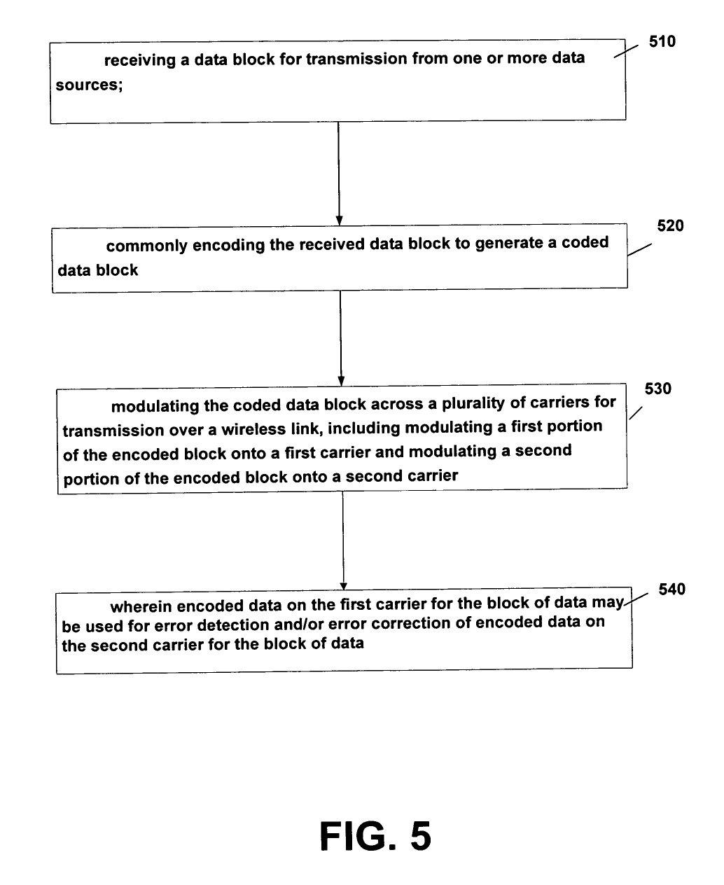

FIG. 5 is a flow chart illustrating operation of a wireless device according to another example embodiment. At 510, a data block for transmission is received from one or more data sources or streams. At 520, the received data block is commonly encoded to generate a coded data block. At 530, the coded data block may be modulated across a plurality of carriers for transmission over a wireless link. The modulating may include modulating a first portion of the encoded block onto a first carrier and modulating a second portion of the encoded block onto a second carrier. At 540, the encoded data on the first carrier for the block of data may be used for error detection and/or error correction of encoded data on the second carrier for the block of data.

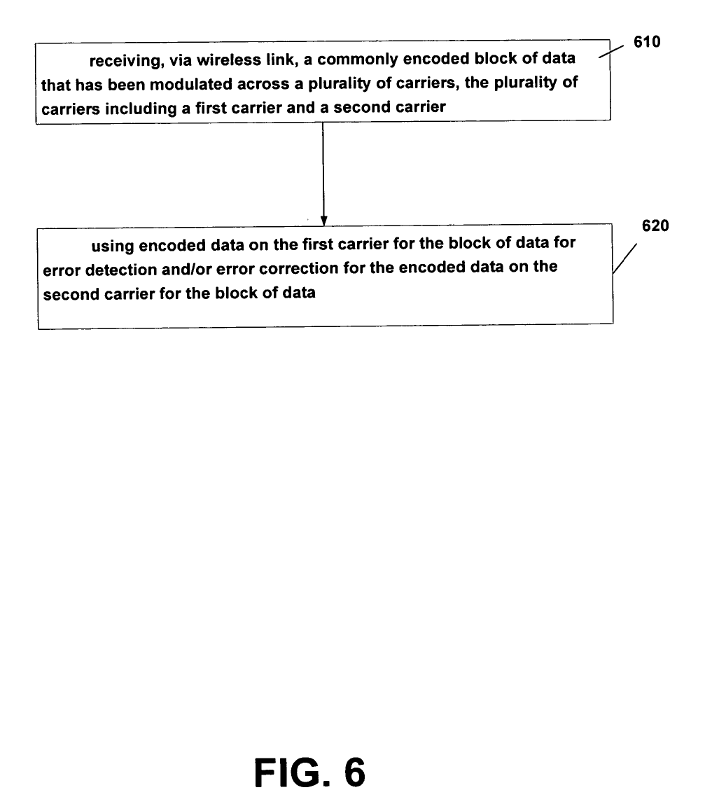

FIG. 6 is a flow chart illustrating operation of a wireless device according to another example embodiment. At 610, a commonly encoded block of data is received via wireless link, where the received block of data has been modulated across a plurality of carriers. The plurality of carriers may include a first carrier and a second carrier. At 620, the encoded data on the first carrier for the block of data is used for error detection and/or error correction for the encoded data on the second carrier for the block of data. For example, the data received via one or more of the carriers may be used to detect and/or correct errors in data received via one of the carriers for the block.

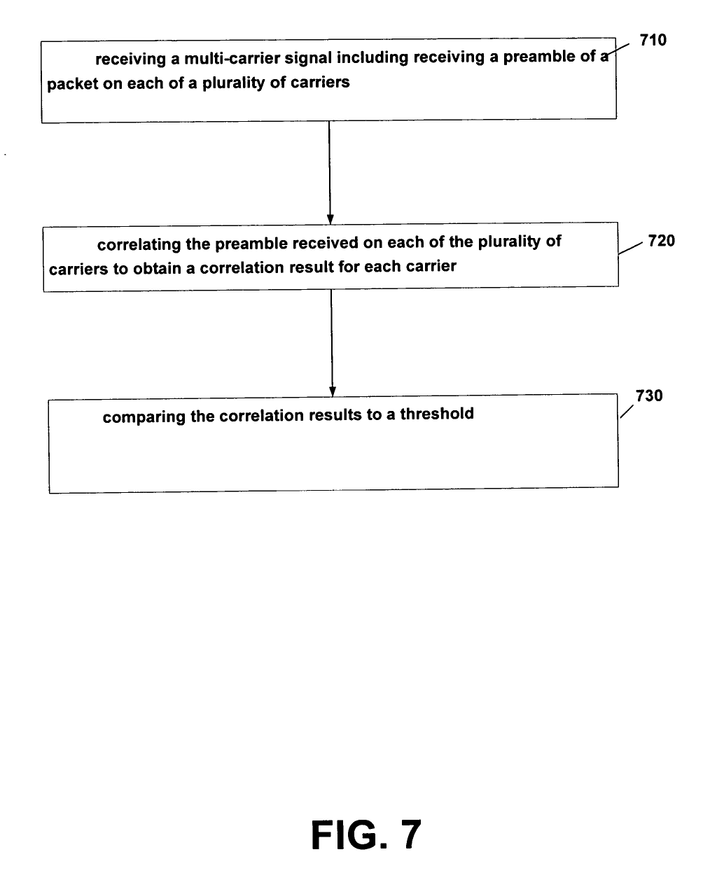

FIG. 7 is a flow chart illustrating operation of a wireless device according to another example embodiment. The flow chart illustrated in FIG. 7 may describe, for example, a technique that may be used by a multicarrier wireless device to detect a packet using data or preambles received via each of a plurality of carriers. At 710, a multi-carrier signal is received, including receiving a preamble of a packet on each of a plurality of carriers. At 720, the preamble received on each of the plurality of carriers may be correlated to obtain a correlation result for each carrier. At 730, the correlation results may be compared to a threshold. For example, the plurality of correlation results may be added together and then compared to a threshold.

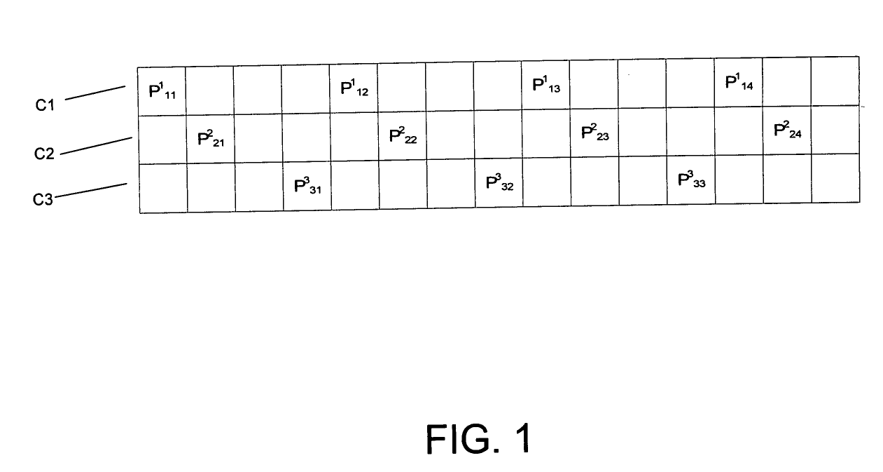

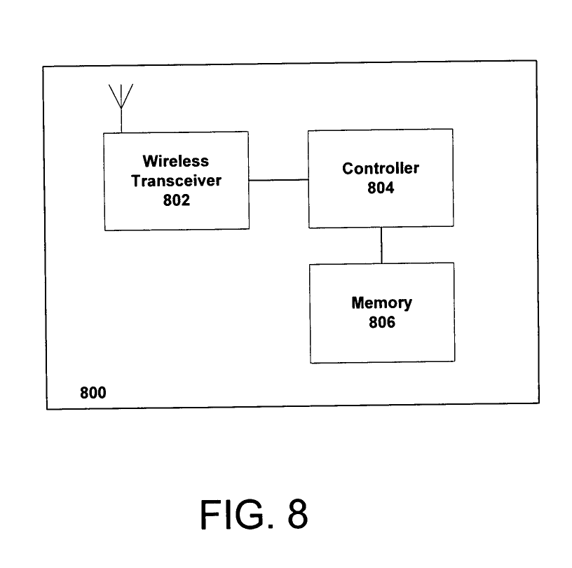

FIG. 8 is a block diagram illustrating an apparatus 800 that may be provided in a wireless apparatus or wireless node according to an example embodiment. The example wireless node may include, for example, a wireless transceiver 802 to transmit and receive signals (which may include transmitter 301 and receiver 321), a controller 804 to control operation of the node or apparatus and execute instructions or software, and a memory 806 to store data and/or instructions. Controller 804 may be programmable, and capable of executing software or other instructions stored in memory or on other computer media to perform the various tasks and functions described above with reference to FIGS. 1-7, for example.

It should be understood that the various embodiments may be used in a variety of devices and applications. Although the embodiments are not limited in this respect, the techniques, methods, circuits or systems disclosed herein may be used in many different apparatus such as in the transmitters and receivers of a radio system, for example. Radio systems intended to be included within the scope of the present embodiments include, by way of example only, wireless network devices and systems such as wireless local area networks (WLAN) devices and wireless wide area network (WWAN) devices including wireless network interface devices, wireless network interface cards (NICs), base stations, access points (APs), gateways, bridges, hubs, cellular radiotelephone communication systems, cellular devices, Access Terminals, Access Network devices, access points, other fixed or mobile transceivers, portable computers, mobile phones, satellite communication systems, two-way radio communication systems, pagers, personal communication systems (PCS), personal computers (PCs), personal digital assistants (PDAs), mobile stations and other wireless devices or radio systems, although the scope of the embodiments is not limited in this respect.

In addition, the various embodiments are applicable to a wide variety of technologies, communication protocols and standards. The examples described herein are provided merely for illustrative purposes and the disclosure or embodiments are not limited thereto.

In addition, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the embodiments or disclosure is not limited thereto. While various aspects of the various example embodiments may be illustrated and described as block diagrams, flow charts, or using some other pictorial representation, it is well understood that these blocks, apparatus, systems, techniques or methods described herein may be implemented in hardware, software, firmware, special purpose circuits or logic, general purpose hardware or controller or other computing device, etc., or some combination thereof.

Embodiments may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. may automatically route conductors and locate components on a semiconductor chip using well established rules of design as well as huge libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

What is claimed is:

1. A method comprising:
commonly encoding a block of data;
modulating the encoded block of data across a plurality of carriers; and
transmitting via a wireless link the encoded block of data including the plurality of carriers.

2. The method of claim 1 wherein the plurality of carriers includes a first carrier and a second carrier, and wherein encoded data on the first carrier for the block of data may be used for error detection and/or error correction of encoded data on the second carrier for the block of data.

3. The method of claim 1 wherein the modulating comprises:
modulating a first portion of the coded data block onto a first carrier; and
modulating a second portion of the coded data block onto a second carrier.

4. The method of claim 3 wherein the transmitting comprises:
spreading a first portion of the encoded block of data using a first spreading code;
spreading a second portion of the encoded block of data using a second spreading code; and
transmitting the first and second portions of the spread data via first and second carriers, respectively;
wherein a preamble for the transmitted first portion of spread data includes a first MAC index to identify the first spreading code, and a preamble for the transmitted second portion of spread data including a second MAC index to identify the second spreading code.

5. The method of claim 4 wherein an allocation of different first and second spreading codes to the different carriers is varied over time.

6. The method of claim 1 wherein the modulating comprises:
interleaving the encoded block of data;
spreading a first portion of the interleaved block of data using a first spreading code;
spreading a second portion of the interleaved block of data using a second spreading code;
modulating the spread first portion of the interleaved block of data onto a first carrier; and
modulating the spread second portion of the interleaved block of data onto a second carrier.

7. The method of claim 1 wherein the transmitting the coded data block comprises transmitting one or more packets or sub-packets for the coded data block substantially synchronously, or at about the same time, for or across the plurality of carriers.

8. A method comprising:
receiving a data block for transmission from one or more data sources;
commonly encoding the received data block to generate a coded data block;
modulating the coded data block across a plurality of carriers for transmission over a wireless link, including modulating a first portion of the encoded block onto a first carrier and modulating a second portion of the encoded block onto a second carrier; and
wherein encoded data on the first carrier for the block of data may be used for error detection and/or error correction of encoded data on the second carrier for the block of data.

9. The method of claim 8 wherein the receiving comprises receiving data from a plurality of sources and combining the received data into a single data block for encoding together.

10. The method of claim 8 wherein the commonly encoding comprises convolutional coding the received data block.

11. The method of claim 8 and further comprising interleaving data within the received data block to provide an interleaved data block, wherein the commonly encoding comprises commonly encoding the interleaved data block to generate a coded data block.

12. The method of claim 8 and further comprising transmitting the encoded block of data across the plurality of carriers.

13. The method of claim 12 wherein the transmitting the coded data block comprises transmitting one or more packets or sub-packets for the coded data block substantially synchronously, or at about the same time, for the plurality of carriers.

14. The method of claim 8 wherein the modulating comprises modulating the coded data block onto a plurality of carriers for transmission over a wireless link, wherein the plurality of carriers include a first carrier and a second carrier, and wherein coded data on the first carrier for the block of data may be used for error detection and/or error correction on the second carrier for the block of data.

15. A method comprising:
receiving, via wireless link, a commonly encoded block of data that has been modulated across a plurality of carriers, the plurality of carriers including a first carrier and a second carrier; and
using encoded data on the first carrier for the block of data for error detection and/or error correction for the encoded data on the second carrier for the block of data.

16. The method of claim 15 and further comprising:
demodulating the received block of data;
de-interleaving the demodulated block of data; and
decoding the de-interleaved block of data.

17. The method of claim 15 and further comprising:
despreading a first portion of the received block of data using a first spreading code;
despreading a second portion of the received block of data using a second spreading code; and
de-interleaving the despread block of data.

18. An apparatus for wireless communication comprising:
an encoder adapted to encode a block of data;
an interleaver adapted to interleave the encoded block of data; and
a multi-carrier modulator adapted to modulate the interleaved block of data across a plurality of carriers, the plurality of carriers including first and second carriers, and wherein the data on the first carrier for the block of data is adapted to be used for error detection and/or error correction for data on the second carrier for the block of data.

19. The apparatus of claim 18 and further comprising a spreader adapted to spread the data that is modulated onto the first carrier using a first spreading code and adapted to spread the data that is modulated onto the second carrier using a second spreading code.

20. An apparatus for wireless communication comprising:
a multi-carrier demodulator adapted to demodulate a received block of data across a plurality of carriers, the block of data having been commonly encoded across the plurality of carriers;
a de-interleaver adapted to de-interleave the demodulated block of data;
a decoder adapted to decode the de-interleaved block of data, wherein the plurality of carriers includes first and second carriers, and wherein the apparatus is adapted to use data on the first carrier for the block of data to perform error detection and/or error correction for data on the second carrier for the block of data.

21. The apparatus of claim 20 and further comprising a despreader adapted to despread data received via the first carrier using a first spreading code and adapted to despread data received via the second carrier using a second spreading code.

22. A method of detecting a packet in a multicarrier wireless system, the method comprising:
receiving a multi-carrier signal including receiving a preamble of a packet on each of a plurality of carriers;
correlating the preamble received on each of the plurality of carriers to obtain a correlation result for each carrier;
comparing the correlation results to a threshold.

23. The method of claim 22 wherein the comparing comprises:
adding the correlation results of the plurality of carriers to provide a multi-carrier correlation sum; and
comparing the correlation sum to a threshold.
